(19) United States
(12) Patent Application Publication
(10) Pub. No.: US 2008/0107841 A1
(43) Pub. Date: May 8, 2008

(54) REFLECTIVE CLEAR COAT COMPOSITION

(75) Inventors: Jeffrey Remillard, Ypsilanti, MI (US); Kenneth Nietering, Dearborn, MI (US); Mark Nichols, Saline, MI (US); John Ginder, Plymouth, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/556,243

(22) Filed: Nov. 3, 2006

(51) Int. Cl. B44F 1/02; C09K 3/00

(52) U.S. Cl. 428/29; 523/135

(57) ABSTRACT

A reflective clear coat composition. In at least one embodiment, the composition includes a clear coat composition including a polymeric binder comprised of one or more resins and reflective flakes having a reflectivity of at least 30% in at least a portion of the near infrared radiation (NIR) region of the solar spectrum and a reflectivity of 29% or less in at least a portion of the visible region of the solar radiation spectrum. The reflective clear coat composition can be cured onto an exterior cured paint surface of an automotive vehicle. The resulting cured clear coat composition may reduce the temperature generated within a vehicle passenger cabin while exposed to solar radiation.

### BACKGROUND OF THE INVENTION

1. Field of the Invention

One aspect of the present invention relates to a reflective clear coat composition. Another aspect of the present invention relates to a reflective clear coat composition for reflecting near infrared radiation (NIR).

2. Background Art

When a vehicle is parked outside on a sunny day, the passenger cabin temperature can become significantly higher than the temperature of the outside air. Upon entering the vehicle after it has been exposed to the sun for a relatively long time, passengers may experience discomfort due to the relatively high temperature of the seats, steering wheel, safety belt latches, and other components, which are often hot to the touch. Moreover, the relatively high passenger cabin temperature may cause internal plastic components, e.g. instrument panels and center consoles, to age at an accelerated rate as compared to the aging rate at lower temperatures.

To reduce the temperature to an acceptable level, passengers often run the air conditioning system on its maximum setting for an extended period of time upon entering the vehicle. A drawback to running the air conditioning system in this manner can be lowered fuel economy, which may increase the amount of undesirable gases, e.g. NOx, hydrocarbons, and CO₂, released into the environment.

The elevation of passenger cabin temperature is primarily a result of the absorption of solar radiation by the vehicle exterior and interior (after it passes through the windows). Approximately half of the energy is in the form of visible light (defined as solar radiation with a wavelength of between 400 nm and 750 nm). Another approximate half of the energy is in the form of near infrared radiation (NIR) (defined as solar radiation with a wavelength between 750 nm and 2500 nm). Additionally, a small fraction, i.e. less than approximately 3%, of energy in the ultraviolet region of the spectrum (defined as solar radiation having a wavelength less than 400 nm) contributes only negligibly to the heating of the vehicle.

The maximum temperature that a vehicle interior reaches on a sunny day in a hot climate can be referred to as the soak out temperature. The vehicle interior includes interior surfaces and interior air environment. The soak out temperature can be affected by many variables including, but not limited to, vehicle shape, vehicle color, vehicle body construction materials, the proportion of glass to metal, vehicle interior materials and color, as well as environmental variables, such as temperature and sunload. Vehicles can reach a surface soak out temperatures of 50° C. to 105° C. in high sunload environments. Moreover, vehicles can reach air soak out temperatures of 30° C. to 80° C. in high sunload environments.

Consumers expect the interior of the vehicle to cool to an acceptable level from the soak out temperature in a reasonable amount of time. This “time to comfort” is a strong function of the interior air temperature and can range from 10 to 25 minutes depending on the temperature, vehicle and vehicle climate control system.

Systems have been proposed to insulate the passenger cabin in order to prevent the entry of heat during sunny exposure. These systems attempt to reduce the soak out temperature, thereby reducing the time to comfort.

According to one proposal, all of the parts of a vehicle forming its boundary with the outside, or at least those parts enclosing the passenger cabin, are provided with an insulating material or molded insulating parts. This proposal can significantly increase the total cost of materials for manufacturing the passenger cabin.

Another proposal suggests painting the vehicle roof and other exterior vehicle surfaces, e.g. doors, with a light color paint, e.g. white or silver, that reflects a significant portion of the visible and NIR portion of the solar spectrum, thereby lowering the amount of energy absorbed by the vehicle. Disadvantageously, this solution excludes the use of darker shaded paints, e.g. black, dark blue, dark green, etc., which are often popular vehicle colors.

In light of the foregoing, what is needed is a reflective clear coat composition including a reflective material that has a relatively high NIR reflectivity, but can be essentially transparent in the visible region of the solar spectrum. Accordingly, the total absorbed solar energy can be reduced, and the soak out temperature can be lowered for any paint color. What is also needed is a reflective clear coat composition that can be cured onto a paint layer coating vehicle exterior parts, e.g. roofs, doors, hoods and trunk lids.

### SUMMARY OF THE INVENTION

According to one aspect of the present invention, a reflective clear coat composition including a reflective material is disclosed. The reflective material can be a reflective flake. The reflective flake has a relatively high near infrared radiation (NIR) reflectivity, but can be essentially transparent in the visible region of the solar radiation spectrum.

According to another aspect of the present invention, a reflective clear coat composition that can cured onto a paint layer coating vehicle exterior parts, e.g. roofs, doors, hoods and trunk lids, is disclosed. The reflective clear coat composition can include reflective flakes. The cured reflective clear coat composition can reflect a high amount of NIR energy, thereby lowering the amount of energy absorbed by the vehicle.

In a first embodiment of the present invention, a reflective clear coat composition is disclosed. The reflective clear coat composition includes a clear coat composition including a polymeric binder comprised of one or more resins and reflective flakes having a reflectivity of at least 30% in at least a portion of the near infrared radiation (NIR) region of the solar spectrum and a reflectivity of 29% or less in at least a portion of the visible region of the solar radiation spectrum.

In a second embodiment of the present invention, a reflective clear coat composition is disclosed. The reflective clear coat composition includes a clear coat composition including a polymeric binder comprised of one or more resins; first reflective flakes having a relatively high reflectivity in a first range of the near infrared radiation (NIR) region of the solar radiation spectrum and a relatively low reflectivity in at least a portion of the visible region of the solar spectrum; second reflective flakes having a relatively high reflectivity in a second range of the NIR region and a relatively low reflectivity in at least a portion of the visible region; and third reflective flakes having a relatively high reflectivity in a third range of the NIR region and a relatively low reflectivity in at least a portion of the visible region. The first, second and third reflective flakes have different reflectivity characteristics.

In a third embodiment of the present invention, an article is disclosed. The article includes a substrate, an electrocoat cured over the substrate, a primer coat cured over the electrocoat, a pigment coat cured over the cured primer coat, and a reflective clear coat cured with or over the cured pigment coat. The reflective clear coat includes a clear coat composition including a polymeric binder comprised of one or more resins; and reflective flakes having a reflectivity of at least 30% in at least a portion of the near infrared radiation (NIR) region of the solar spectrum and a reflectivity of 29% or less in at least a portion of the visible region of the solar radiation spectrum.

### BRIEF DESCRIPTION OF THE DRAWINGS

FIG. 1 is a schematic, cross sectional, side view of a vehicle cabin according to one embodiment of the present invention;

FIG. 2 is a perspective view of a reflective flake according to one embodiment of the present invention;

FIG. 3 is a cross sectional view of the reflective flake of FIG. 2 taken along line 3-3; and

FIG. 4 is a fragmented, side view of a painted vehicle roof according to one embodiment of the present invention; and

FIG. 5 is a graph depicting solar irradiance versus wavelength and the representative reflectivity profiles of various reflective flakes according to certain embodiments of the present invention.

### DETAILED DESCRIPTION OF EMBODIMENTS OF THE PRESENT INVENTION

Except where expressly indicated, all numerical quantities in this description indicating amounts of material or conditions of reaction and/or use are to be understood as modified by the word “about” in describing the broadest scope of the present invention. Practice within the numerical limits stated is generally preferred.

The description of a single material, compound or constituent or a group or class of materials, compounds or constituents as suitable for a given purpose in connection with the present invention implies that mixtures of any two or more single materials, compounds or constituents and/or groups or classes of materials, compounds or constituents are also suitable. Also, unless expressly stated to the contrary, percent, “parts of,” and ratio values are by weight. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

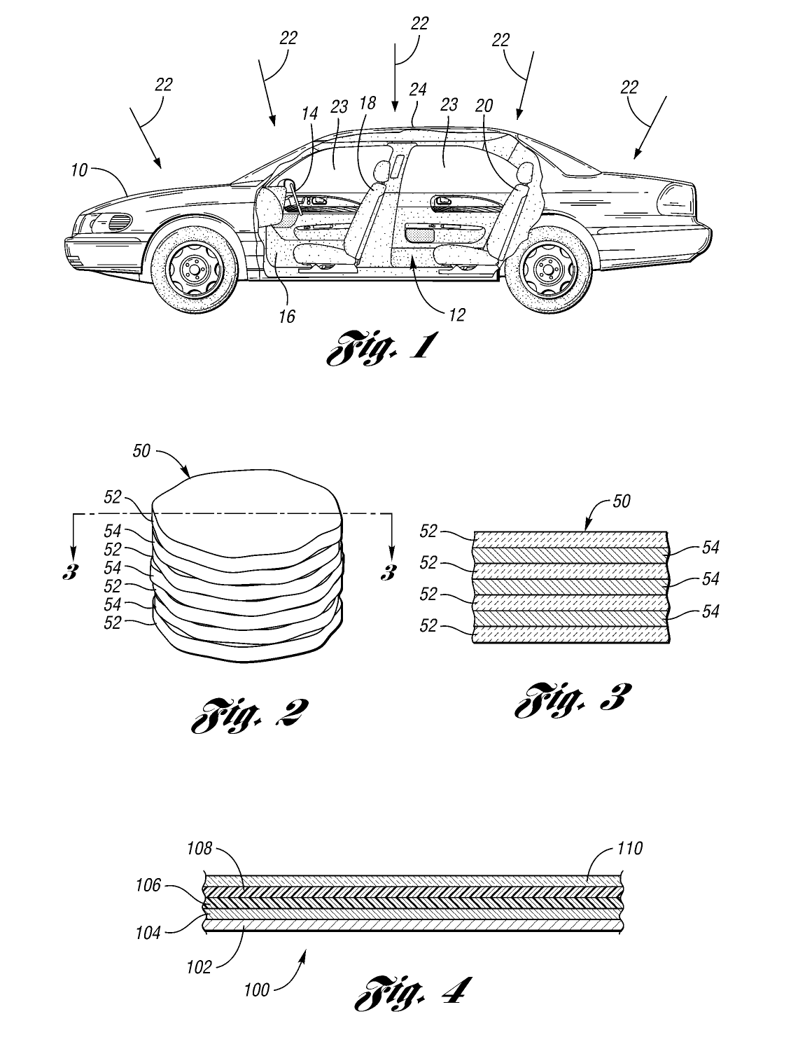

With reference to FIG. 1, a schematic, cross sectional, side view of vehicle 10 is illustrated. Passenger cabin 12 is situated within vehicle 10, and includes several internal components, for example, a steering wheel 14, center console 16, and seats 18 and 20. In certain embodiments, the steering wheel 14 and center console 16 can be formed of plastic. In certain embodiments, the internal components of the seats 18 and 20 can be formed of metal and foam. The covering of each of the seats 18 and 20 can be formed of a fabric material. It should be appreciated that the passenger cabin typically includes several other internal components, for example, safety latches and cup holders.

When vehicle 10 is parked and exposed to the sun, vehicle 10 absorbs solar radiation, depicted by the arrows 22. The solar radiation is absorbed by the vehicle exterior 24 and the vehicle interior, i.e. the passenger cabin 12, after the solar radiation passes through the windows 23. The absorption of solar radiation heats the air within passenger cabin 12, thereby elevating the temperature of the passenger cabin 12 as compared to the external air temperature.

The solar radiation spectrum is comprised of visible light (defined as solar radiation with a wavelength of between 400 nm and 750 nm) and near infrared radiation (NIR) (defined as solar radiation with a wavelength of between 750 nm and 2500 nm). It should be appreciated that a small fraction, i.e. less than approximately 3% of solar radiation, consists of ultraviolet radiation (defined as solar radiation with a wavelength of less than 400 nm).

Approximately half of the solar energy incident on the vehicle 10 is in the form of visible light. The other half of the incident solar radiation is in the form of NIR. FIG. 5 is a graph 150 plotting solar irradiance 152 (units=W m⁻² nm⁻¹) as a function of wavelength (units=nm)

According to one embodiment of the present invention, a reflective clear coat composition having a relatively high reflectivity of NIR and an insignificant level of reflectivity of visible light is disclosed. The reflective clear coat composition can be applied to painted exterior vehicle parts, e.g. the roof and doors.

In at least one embodiment, the reflective clear coat composition is comprised of a clear coat composition including a polymeric binder comprised of one or more resins and a reflective material. The clear coat composition can further include one or more additives including, but not limited to, stabilizers (e.g. hindered amine light stabilizers or ultraviolet light absorbers), rheology control additives, flow control additives and other additives to achieve certain appearance and/or durability characteristics. According to one embodiment, the reflective material is a reflective flake. The reflective flakes have a relatively high level of reflectivity in at least a portion of the NIR region and an insignificant level of reflectivity in the visible light region.

Non-limiting examples of clear coat compositions that are suitable for use in accordance with the present invention include, in no particular order: (1) thermally cured one-component solvent-borne clear coats, such as acrylic-melamine clear coats, epoxy-acid clear coats, polyester clear coats, and alkyd clear coats; (2) thermally cured two-component solvent-borne clear coats, such as polyurethane clear coats, epoxy-acid clear coats, epoxy-thiol clear coats, and thiourethane clear coats; (3) radiation cured solvent-borne clear coats, such as urethane acrylate clear coats, epoxy acrylate clear coats, thiourethane clear coats, epoxy-acid clear coats, urethane clear coats, and ester-acrylate clear coats; (4) thermally cured powder clear coats, such as epoxy clear coats, polyester clear coats, acrylic clear coats, and urethane clear coats; and (5) thermally cured water-borne clear coats, such as polyurethane clear coats.

In at least one embodiment, the reflective flakes are comprised of a number of layers of dielectric material. According to one embodiment, a multi-layer reflective flake is comprised of alternating layers of a high index of refraction material and a low index of refraction material. A non-limiting example of a suitable low index of refraction material is silicon dioxide, and a non-limiting example of a suitable high index of refraction material is titanium dioxide. The layers can be grown on a polymeric substrate using standard vacuum deposition processes, including, for example, thermal evaporation, electronic beam evaporation, and sputtering techniques. Flakes are formed by releasing the grown material from the substrate using, for example, mechanical grinding. Reflective flakes, such as those described above, can be obtained from Flex Products Inc., of Santa Rosa, Calif.

In certain embodiments, reflective flakes are mixed into the clear coat composition. The mixing can be accomplished through mechanical dry or wet milling. Alternatively, the mixing can be accomplished by blending with various solvents and resins to aid in the dispersion of the flakes within the clear coat in such a manner as pigments are typically dispersed within a basecoat.

In certain embodiments, the reflective flakes can comprise from 0.25 to 20 weight percentage (%) of the total weight of the reflective clear coat composition. In other embodiments, the reflective flakes can comprise from 1 to 5 weight % of the total weight of the reflective clear coat composition.

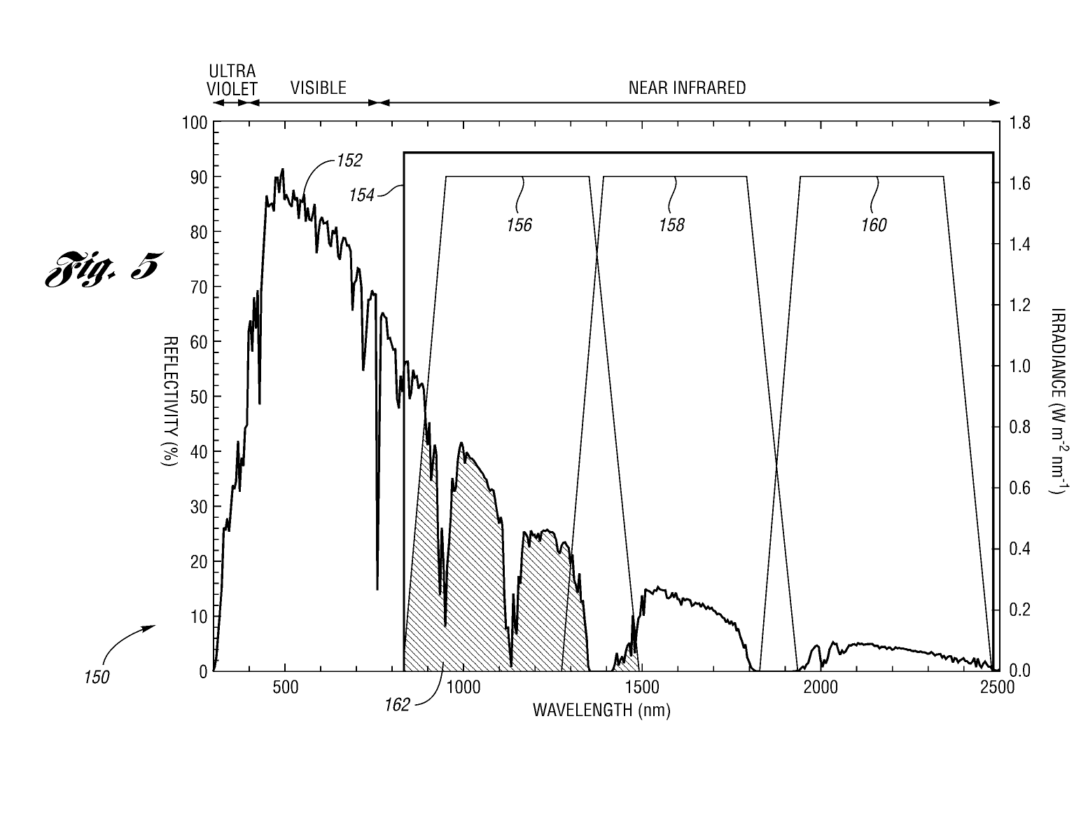

FIGS. 2 and 3 depict an example of a reflective flake 50 according to one embodiment of the present invention. The reflective flake 50 has an irregular disc-like shape and is comprised of alternating layers of high index of refraction material 52 and low index of refraction material 54. For example, the high index of refraction layer can be comprised of titanium dioxide and the low index of refraction layer can be comprised of silicon dioxide. Another pair of suitable materials is zinc sulfide for the high index of refraction layer and magnesium fluoride for the low index of refraction layer. The layer thicknesses can be optimized within the ranges set forth below to provide a high reflectivity in the near infrared region of the solar spectrum. For example, the low index of refraction layer can be a first thickness and the high index of refraction layer can be a second thickness. where the thicknesses differ.

Disc-like reflective flakes, for example, reflective flake 50, can have a diameter in the range of 5 to 50 microns and a thickness in the range of 0.5 to 5 microns. It should be appreciated that other reflective flake shapes can be utilized in accordance with the present invention, for example, rectangular or triangular shaped reflective flakes.

According to at least one embodiment, a single type of reflective flake is mixed with the clear coat composition. In other embodiments, two or more types of reflective flakes can be mixed with the clear coat composition.

Whether one or multiple types of flakes are utilized may depend on the reflectivity characteristics of the flake types. FIG. 5 is a graph 150 that illustrates curves depicting the spectral-reflectivity characteristics of several different reflective flake types. Curve 154 depicts the spectral-reflectivity of an “ideal” flake, defined as having zero reflectivity for visible wavelengths and a relatively high reflectivity in the NIR region. It should be appreciated that in other embodiments, a relatively low reflectivity in the visible wavelengths is suitable. The relatively low visible wavelength reflectivity can be in the range of 0% to 29%, and in other embodiments, 0% to 10%. According to FIG. 5, the relatively high NIR reflectivity in the NIR region is 93%. It should be appreciated that in other embodiments, a relatively high NIR reflectivity may be in the range of 25% to 99% reflectivity, and in other embodiments 30% to 80% reflectivity, or other ranges that can be defined by selecting a lower percentage and higher percentage of the percentages set forth herein. The reflectivity percentages of the flakes can be measured by any device known to one of ordinary skill in the art, such a UV-VIS-NIR spectrophotometer.

In at least one embodiment, a reflective clear coat composition including a reflective flake may have a different reflectivity than the reflective flake itself due to the process of incorporating the reflective flake into the clear coat. The resultant reflective clear coat can be used in accordance with certain embodiments of the present invention if the clear coat has a relatively low visible wavelength reflectivity and a relatively high NIR reflectivity. The relatively low visible wavelength reflectivity can be in the range of 0% to 29%, and in other embodiments, 0% to 10%. The relatively high NIR reflectivity may be in the range of 25% to 99% reflectivity, and in other embodiments 30% to 80% reflectivity, or other ranges that can be defined by selecting a lower percentage and higher percentage of the percentages set forth herein. In at least one embodiment of the present invention, the reflective clear coat composition can be used with a base coat that transmits in the NIR and a primer coat that has a relatively high NIR reflectivity. According to this embodiment, a reduction of heat load can be realized. For example, the heat load of a black vehicle can be reduced from 1000 Watts per square meter or greater to 700 to 950 Watts per meter squared, or 700 to 750 Watts per meter squared.

One aspect of the present invention uses two or more reflective flake types to cover a desired spectral region. Curves 156, 158 and 160 depict the spectral-reflectivity plots of three different reflective flakes, each having a different center wavelength. In certain embodiments, all three types of flakes can be added to a clear coat composition, thereby covering essentially the entire NIR spectrum.

It should be appreciated that the entire NIR spectrum does not have to be covered for the reflective flakes to have the beneficial effect of reducing the heat absorbed by a vehicle. For instance, a single flake type can be formed that covers a substantial fraction of the NIR region. For example, the flake corresponding to curve 156 has a spectral-reflectivity profile that can reflect a substantial fraction of the solar NIR. The shaded portion 162 depicts the substantial fraction of the NIR covered by the single flake type.

FIG. 4 depicts a fragmented, side view of a vehicle exterior paint system 100 according to one embodiment of the present invention. An electrocoat 104 is deposited and cured over vehicle body 102. A primer coat 106 is cured over the cured electrocoat 104. A pigment coat 108 is then applied over the cured primer coat 106. A reflective clear coat 110 is then applied and cured with the pigment coat 108 over the cured primer coat 106. In an alternative embodiment, the primer coat 106 can be cured co-commitantly with the pigment coat 108 and the clear coat 110. Alternatively, all the layers could be cured separately. It should be appreciated that any conventional curing process can be utilized to carry out the curing steps identified above. Non-limiting examples of curing processes include thermal curing, radiation curing (ultraviolet or electro bar), and room temperature curing.

Having thus described several embodiments of the present invention, the following non-limiting examples illustrate the use of a reflective clear coat composition suitable for reducing the amount of heat absorbed by a vehicle.

### EXAMPLE 1

According to Example 1, three different types of reflective flakes are utilized. The reflective flakes can be obtained, for example, from Flex Products, Inc. The spectral-reflectivity characteristic of the first reflective flake is depicted by curve 156 of FIG. 5. The center wavelength of the first reflective flake is 1150 nm. The maximum reflectivity percentage (%) for the first reflective flake is 88%. The spectral-reflectivity characteristic of the second reflective flake is depicted by curve 158 of FIG. 5. The center wavelength of the second reflective flake is 1600 nm. The maximum reflectivity percentage (%) for the second reflective flake is 88%. The spectral-reflectivity characteristic of the third reflective flake is depicted by curve 160 of FIG. 5. The center wavelength of the second reflective flake is 2150 nm. The maximum reflectivity percentage (%) for the third reflective flake is 88%.

Each flake type is loaded into the clear coat composition of a carbamate type available from BASF Corp., in a weight % of 5% of the total weight of the reflective clear coat composition.

The reflective clear coat composition of Example 1 has been found to effectively reflect most of the radiation in the NIR spectrum.

### EXAMPLE 2

While Example 1 is suitable for preparing an ideal reflective clear coat composition in terms of reflecting essentially all of the NIR produced by solar irradiance, Example 2 relates to a reflective clear coat composition that reflects a substantial fraction of NIR.

According to Example 2, a single type of reflective flake is utilized, available from Flex Products, Inc. The spectral-reflectivity characteristic of the reflective flake is depicted by curve 156 of FIG. 5. The center wavelength of the first reflective flake is 1150 nm. The maximum reflectivity percentage (%) for the reflective flake is 88%.

The flake is loaded into the clear coat composition of a carbamate type available from BASF Corp in a weight % of 5% of the total weight of the reflective clear coat composition.

As depicted by the shaded area 162 under the solar irradiance curve 152 of FIG. 5, a substantial fraction of the total NIR is covered by curve 156. Therefore, the reflective clear coat composition of Example 2 is suitable for reflecting a substantial fraction of the solar NIR.

As required, detailed embodiments of the present invention are disclosed herein. However, it is to be understood that the disclosed embodiments are merely exemplary of an invention that may be embodied in various and alternative forms. While embodiments of the have been illustrated and described, it is not intended that these embodiments illustrate and describe all possible forms of the invention. Rather, the words used in the specification are words of description rather than limitation, and it is understood that various changes may be made without departing from the spirit and scope of the invention.

In accordance with the provisions of the patent statute, the principle and mode of operation of this invention have been explained and illustrated in its various embodiments. However, it must be understood that this invention may be practiced otherwise than as specifically explained and illustrated without departing from its spirit or scope.

What is claimed is:

1. A reflective clear coat composition comprising:
a clear coat composition including a polymeric binder comprised of one or more resins; and
reflective flakes having a reflectivity of at least 30% in at least a portion of the near infrared radiation (NIR) region of the solar spectrum and a reflectivity of 29% or less in at least a portion of the visible region of the solar radiation spectrum.

2. The reflective clear coat composition of claim 1, wherein a substantial portion of the reflective flakes have a substantially similar shape and a substantially similar size.

3. The reflective clear coat composition of claim 3, wherein the substantially similar shape is an irregular disc-like shape and the substantially similar size includes a diameter selected from the range of 5 to 50 microns and a thickness selected from the range of 0.5 to 5 microns.

4. The reflective clear coat composition of claim 3, wherein the diameter is 20 microns and the thickness is 1 micron.

5. The reflective clear coat composition of claim 1, wherein each of the reflective flakes is comprised of an alternating layer pair of a high index of refraction material and a low index of refraction material.

6. The reflective clear coat composition of claim 1, wherein the reflective flakes include a first type of reflective flake and a second type of reflective flake, the first type of reflective flake having a relatively high reflectivity in a first range of the NIR region, and the second type of reflective flake having a relatively high reflectivity in a second range of the NIR region.

7. The reflective clear coat composition of claim 6, wherein the reflective flakes include a third type of reflective flake, the third type of reflective flake having a relatively high reflectivity in a third range of the NIR region.

8. The reflective clear coat composition of claim 7, wherein the first, second and third ranges are overlapping.

9. The reflective clear coat composition of claim 7, wherein the first, second and third ranges are discrete.

10. The reflective clear coat composition of claim 7, wherein the first range is 750 to 1500 nanometers (nm), the second range is 1300 to 1900 nanometers (nm), and the third range is 1800 to 2500 nm.

11. The reflective clear coat composition of claim 7, wherein the first, second and third ranges collectively substantially cover the entire NIR region.

12. The reflective clear coat composition of claim 1, wherein the reflective flakes comprise from 0.25 to 20 weight percent of the total weight of the reflective clear coat composition.

13. The reflective clear coat composition of claim 7, wherein the first type of reflective flake comprises from 0.25 to 20 weight percent of the reflective clear coat composition, the second type of reflective flake comprises from 0.25 to 20 weight percent of the reflective clear coat composition, and the third type of reflective flake comprise from 0.25 to 20 weight percent of the reflective clear coat composition.

14. The reflective clear coat composition of claim 1, wherein each of the reflective flakes has approximately zero reflectivity in the visible region.

15. The reflective clear coat composition of claim 1, wherein the clear coat composition further includes one or more additives.

16. A reflective clear coat composition comprising:
a clear coat composition including a polymeric binder comprised of one or more resins;
first reflective flakes having a reflectivity of at least 30% in a first range of the near infrared radiation (NIR) region of the solar radiation spectrum and a reflectivity of 29% or less in at least a portion of the visible region of the solar spectrum;
second reflective flakes having a reflectivity of at least 30% in a second range of the NIR region and a reflectivity of 29% or less in at least a portion of the visible region; and
third reflective flakes having a reflectivity of at least 30% in a third range of the NIR region and a reflectivity of 29% or less in at least a portion of the visible region,
the first, second and third reflective flakes having different reflectivity characteristics.

17. The reflective clear coat composition of claim 16, wherein the first, second and third ranges collectively substantially cover the entire NIR.

18. An article comprising:
a substrate;
an electrocoat cured over the substrate;
a primer coat cured over the electrocoat;
a pigment coat cured over the cured primer coat; and
a reflective clear coat cured with or over the cured pigment coat and comprising:
a clear coat composition including a polymeric binder comprised of one or more resins; and
reflective flakes having a reflectivity of at least 30% in at least a portion of the near infrared radiation (NIR) region of the solar spectrum and a reflectivity of 29% or less in at least a portion of the visible region of the solar radiation spectrum.

19. The article of claim 18, wherein the substrate is a vehicle body and the article is a vehicle.

20. The article of claim 18, wherein each of the reflective flakes has a substantially similar shape and a substantially similar size, the substantially similar shape is an irregular disc-like shape and the similar size includes a diameter selected from the range of 5 to 50 microns and a thickness selected from the range of 0.5 to 5 microns.
